(19) United States
(12) Patent Application Publication
(10) Pub. No.: US 2021/0230920 A1
(43) Pub. Date: Jul. 29, 2021

(54) Oven Door Assembly with Adjustable Center of Gravity

(71) Applicant: Haier US Appliance Solutions, Inc., Wilmington, DE (US)

(72) Inventors: Caleb Farrel, Jeffersonville, IN (US); Eric Matthew Lewis, Louisville, KY (US)

(21) Appl. No.: 16/774,275

(22) Filed: Jan. 28, 2020

(51) Int. Cl. E05D 13/00; A21B 3/02

(52) U.S. Cl. CPC E05D 13/14; A21B 3/02; E05Y 2201/50; E05Y 2600/10; E05Y 2201/416; E05Y 2900/308

(57) ABSTRACT

A door assembly for providing selective access to a chamber of an appliance includes adjustable balancing masses mounted to the door assembly to enable adjustment of the door assembly's center of gravity. Specifically, the door assembly includes one or more spring hinges attaching the door assembly to the appliance cabinet. Balancing mass are positioned on a mounting apparatus attached to the frame of the door assembly. To achieve an appropriate balance between the gravitational moment of the door assembly and the torsional stiffness of the spring hinges, the balancing masses may be adjusted on the mounting apparatus, thereby altering the center of gravity and gravitational moment generated by the door assembly to a predetermined amount appropriate for a given torsional stiffness of the spring hinge.

### FIELD OF THE INVENTION

The present subject matter relates generally to door assemblies for appliances, and more particularly, to a mechanism employing balancing masses adjustably mounted to the door assembly to create a predetermined gravitational moment.

### BACKGROUND OF THE INVENTION

Conventional residential and commercial oven appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber.

Conventional oven appliances further include a door that is pivotally mounted to the oven cabinet via a spring hinge, e.g., to insulate and provide selective access to the cooking chamber. Traditionally, assembly of such oven appliances occurs in manufacturing settings in which a wide variety of oven models are being produced. Consequently, an assembler must select among a variety of oven doors having varying masses and dimensions, depending on which model oven is to be assembled. Oven doors of different models have differing configurations and thus different centers of gravity. As such, each door configuration exerts a different gravitational moment on the spring hinges connecting the door to the cabinet. Traditionally, this problem was addressed by maintaining a large inventory of spring hinge variants with different levels of torsional stiffness. The assembler would then be required to specially calibrate each assembly to ensure that the proper hinges were used to counterbalance the gravitational moment generated by the door.

Accordingly, an improved door assembly for an appliance and method of assembly would be useful. More particularly, a door assembly comprising one or more balancing masses adjustably mounted to the door assembly to alter the door's center of gravity would be especially beneficial, as a single spring hinge could be used for all door assemblies, regardless of the mass and dimensions of the door assembly, thus simplifying the manufacturing and logistics of assembly.

### BRIEF DESCRIPTION OF THE INVENTION

Aspects and advantages of the invention will be set forth in part in the following description, or may be apparent from the description, or may be learned through practice of the invention.

In a first example embodiment, a door assembly for providing selective access to a chamber of an appliance is provided. The door assembly includes a frame, a hinge for rotatably coupling the frame to the appliance, a mounting apparatus, and a balancing mass. The frame defines a vertical, a later, and a transverse direction. The mounting apparatus is attached to the frame. The balancing mass is position on the mounting apparatus such that the frame and the balancing mass exert a predetermined gravitational moment on the hinge. The balancing mass is at least partially contained within the volume defined by the frame.

In a second example embodiment, an oven appliance is provided. The oven appliance includes a cabinet, a cooking chamber positioned within the cabinet, and a door assembly rotatably mounted to the cabinet for providing selective access to the cooking chamber. The door assembly includes a frame, a hinge for rotatably coupling the frame to the appliance, a mounting apparatus, and a balancing mass. The frame defines a vertical, a later, and a transverse direction. The mounting apparatus is attached to the frame. The balancing mass is position on the mounting apparatus such that the frame and the balancing mass exert a predetermined gravitational moment on the hinge. The balancing mass is at least partially contained within the volume defined by the frame.

In a third example embodiment, a method of balancing a door assembly of an appliance is provided. The method includes rotatably coupling a frame of the door assembly to the appliance using a hinge having a predetermined torsional stiffness, attaching a mounting apparatus to the frame of the door assembly, and adjusting a balancing mass attached to the mounting apparatus.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front perspective view of an oven appliance according to an exemplary embodiment of the present subject matter.

FIG. 2 is a schematic, cross sectional view of the exemplary oven appliance of FIG. 1, taken along Line 2-2 in FIG. 1.

FIG. 3 is a perspective view of a door assembly employing ball screw mounting apparatuses in accordance with an embodiment of the present subject matter.

FIG. 4 is a perspective view of a door assembly employing adhesive mounting apparatuses in accordance with an embodiment of the present subject matter.

FIG. 5 is a perspective view of a door assembly employing clip mechanism mounting apparatuses in accordance with an embodiment of the present subject matter.

FIG. 6 provides a method of balancing a door assembly of an appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

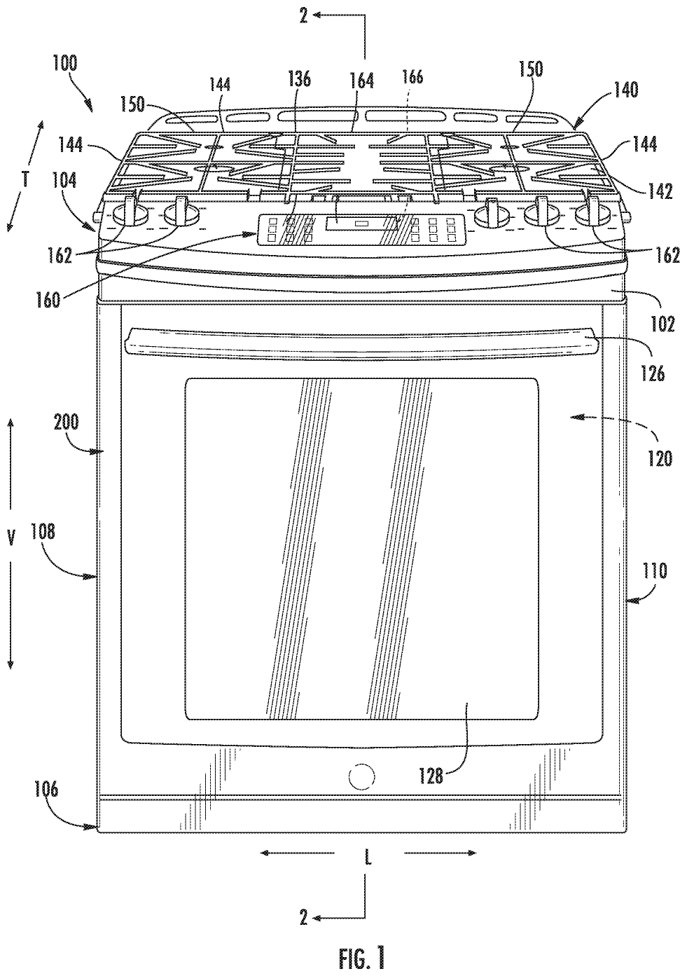

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to door assemblies for any suitable appliance.

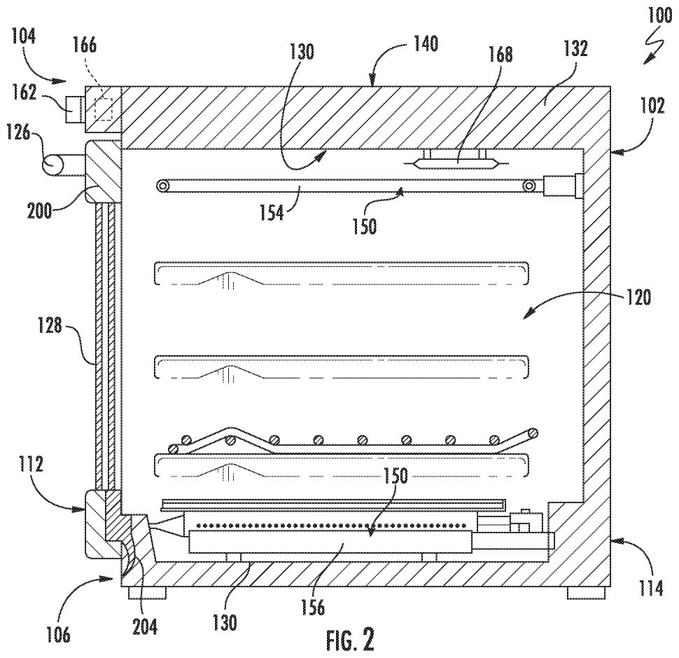

Oven appliance 100 includes a door assembly 200 rotatably attached to cabinet 102 in order to permit selective access to cooking chamber 120. Handle 126 is mounted to door assembly 200 to assist a user with opening and closing door assembly 200 in order to access cooking chamber 120. As an example, a user can pull on handle 126 mounted to door assembly 200 to open or close door assembly 200 and access cooking chamber 120. One or more transparent viewing windows 128 (FIG. 1) may be defined within door assembly 200 to provide for viewing the contents of cooking chamber 120 when door assembly 200 is closed and also assist with insulating cooking chamber 120. Door assembly 200 is rotatably coupled to oven appliance 100 via hinges 204 (FIG. 2).

In general, cooking chamber 120 is defined by a plurality of chamber walls 130 (FIG. 2). Specifically, cooking chamber 120 may be defined by a top wall, a rear wall, a bottom wall, and two sidewalls 130. These chamber walls 130 may be joined together to define an opening through which a user may selectively access cooking chamber 120 by opening door assembly 200. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Oven appliance 100 may further include one or more heating elements (identified generally by reference numeral 150) for selectively heating cooking utensils positioned on grates 144 or food items positioned within cooking chamber 120. For example, referring to FIG. 1, heating elements 150 may be gas burners 150. Specifically, a plurality of gas burners 150 are mounted within or on top of top panel 142 such that grates 144 support cooking utensils over gas burners 150 while gas burners 150 provide thermal energy to cooking utensils positioned thereon, e.g., to heat food and/or cooking liquids (e.g., oil, water, etc.). Gas burners 150 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 (also referred to as a broil heating element or gas burner) may be positioned in cabinet 102, e.g., at a top portion of cooking chamber 120, and a lower gas heating element 156 (also referred to as a bake heating element or gas burner) may be positioned at a bottom portion of cooking chamber 120. Upper gas heating element 154 and lower gas heating element 156 may be used independently or simultaneously to heat cooking chamber 120, perform a baking or broil operation, perform a cleaning cycle, etc. The size and heat output of gas heating elements 154, 156 can be selected based on the, e.g., the size of oven appliance 100 or the desired heat output. Oven appliance 100 may include any other suitable number, type, and configuration of heating elements 150 within cabinet 102 and/or on cooktop 140. For example, oven appliance 100 may further include electric heating elements, induction heating elements, or any other suitable heat generating device.

A user interface panel 160 is located within convenient reach of a user of the oven appliance 100. For this exemplary embodiment, user interface panel 160 includes knobs 162 that are each associated with one of heating elements 150. In this manner, knobs 162 allow the user to activate each heating element 150 and determine the amount of heat input provided by each heating element 150 to a cooking food items within cooking chamber 120 or on cooktop 140. Although shown with knobs 162, it should be understood that knobs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user input devices 136. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of a single oven appliance, it should be appreciated that oven appliance 100 is provided by way of example only. Other oven or range appliances having different configurations, different appearances, and/or different features may also be utilized with the present subject matter, e.g., double ovens, standalone cooktops, etc. Moreover, aspects of the present subject matter may be used in any other consumer or commercial appliance which includes a door, particularly those with viewing windows.

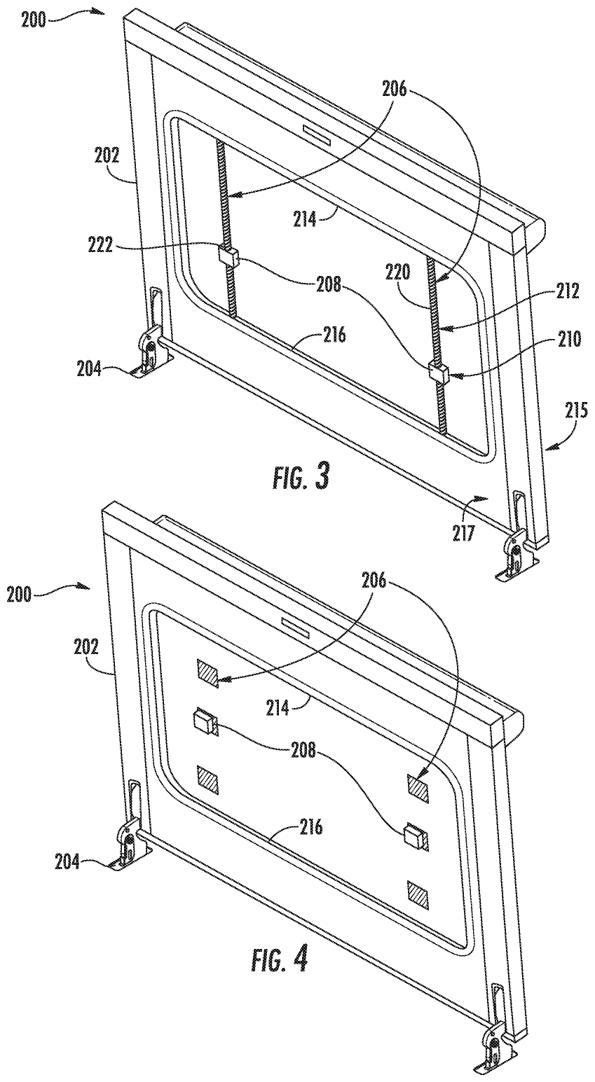

Referring now to FIG. 3, a perspective view of one embodiment of door assembly 200 is provided. By opening and closing door assembly 200, selective access to cooking chamber 120 may be provided. Door assembly 200 comprises a frame 202. When door assembly 200 is in a closed position (i.e., door assembly 200 prevents access to cooking chamber 120), frame 202 defines a vertical, a lateral, and a transverse direction.

Door assembly 200 further comprises one or more hinges 204. A first end of hinges 204 may be coupled to frame 202 and second end or hinges 204 may be coupled to oven appliance 100 in any manner known in the art. As depicted in the embodiment of FIG. 2, hinges 204 may be mounted at one or more positions along the bottom of door assembly 200. However, it should be understood any other suitable number, type, position, and configuration of hinges may be employed in alternative embodiments, such as side mounted hinges. When door assembly 200 is mounted to oven appliance 100 via hinges 204, door assembly 200 may pivot about the axis of hinges 204 between open and closed positions. In some embodiments, hinges 204 may include a torsional spring which acts to pivotably rotate door assembly 200 to oven appliance 100, i.e., toward the closed position.

Of course, different springs have different torsional stiffnesses and thus exert different rotational forces on door assembly 200. Thus, a spring hinge with a lower torsional stiffness may be appropriate to counteract the gravitational moment generated by a smaller, lightweight door, but may be insufficient to provide adequate aid in the opening or closing of a bulkier, heavier door. In contrast, a spring hinge having a higher torsional stiffness may balance out the gravitational moment of a larger, heavier door, but may cause a lighter, smaller door to slam shut. Due to the wide variety of combinations of hinges and oven doors that could be employed in the manufacture and assembly of commercially available ovens, it is desirable to have an apparatus and method of adjusting a door assembly to ensure compatibility between selected spring hinges and oven doors.

In one embodiment, the present subject matter addresses this problem by employing one or more balancing masses 208 which may be mounted to varying locations on one or more mounting apparatuses 206 on frame 202 of door assembly 200. Mounting of the balancing mass 208 at different mounting locations may impact the center of gravity of door assembly 200, thus changing the gravitational moment that door assembly 200 exerts on hinge 204. This enables variation in assembly of door assembly 200 to account for the known torsional stiffness of hinge 204.

To illustrate this, FIG. 3 depicts two mounting apparatuses 206 attached to frame 202 of door assembly 200. Although this embodiment employs two mounting apparatuses 206, aspects of the present subject matter may use a single mounting apparatus 206 or more than two mounting apparatuses 206, as desired and practical in a given application. Balancing masses 208 may be positioned at various locations along mounting apparatuses 206. In the embodiment of FIG. 3, mounting apparatuses 206 extend in the vertical direction. Thus, positioning balancing mass 208 higher (i.e., further from hinge 204 in the vertical direction) on mounting apparatus 206 raises the center of gravity of door assembly 200. Conversely, positioning balancing mass 208 lower (i.e., closer to hinge 204 in the vertical direction) on mounting apparatus 206 lowers the center of gravity of door assembly 200.

In the embodiment of FIG. 3, one end of each mounting apparatus 206 may be attached to an upper wall 214 of frame 202 and the other end of mounting apparatuses 206 may be attached to a lower wall 216 of frame 202, wherein upper wall 214 and lower wall 216 are disposed opposite one another in the vertical direction. In some embodiments, upper wall 214 and lower wall 216 may be at the top-most and bottom-most portions of frame 202. In other embodiments, upper wall 214 and lower wall 216 may be located at other positions on frame 202, such as the top and bottom boundary of a window within frame 202. Moreover, the present subject matter is not limited to adjustment in the vertical direction only. Instead, balancing mass 208 may be adjusted in a transverse direction T to alter the center of gravity of door assembly 200. In such embodiments, one end of each mounting apparatus 206 may be attached to a front wall 215 and the other end of mounting apparatus 206 may be attached to a back wall 217. In addition, or alternatively, balancing mass 208 may be adjusted in a lateral direction L to alter the center of gravity of door assembly 200.

In some embodiments, mounting apparatus 206 and balancing mass 208 are at least partially contained within a volume defined by frame 202. In other embodiments, mounting apparatus 206 and balancing mass 208 are fully contained within the volume defined by frame 202, thus hiding the adjustment mechanism from view of end users and discouraging readjustment of balancing mass 208.

The center of gravity of door assembly 200 determines the gravitational moment exerted on hinge 204. Thus, a balancing mass mounting position may be selected to create a gravitational moment that is appropriately balanced against a known torsional stiffness of hinge 204. This enables a simplification of the assembly process, permitting the assembler to, for example, use a single, high tension spring hinge 204—regardless of the door assembly 200 to be used—and then to alter the center of gravity of door assembly 200 by selecting the appropriate position of balance mass 208 on mounting apparatus 206, or otherwise adjusting balancing mass 208, to achieve a predetermined gravitational moment that provides an appropriate balance based on the counteracting force generated by the torsional stiffness of hinge 204.

Although the gravitational moment and torsional stiffness are described herein as being “predetermined,” it should be appreciated that aspects of the present subject matter may not involve the calculation or determination of actual moment or stiffness values. Instead, door assembly 200 may be balanced by a technician or assembler by simply installing the door assembly 200 and adjusting the mass until the proper balance is achieved. Alternatively, the torsional stiffness of the spring may be a known value and the mass may be positioned at a specific location based on the specific door configuration being used, e.g., based on a model number and empirical data regarding the center of gravity of that door. In such circumstances, the predetermined gravitational moment may be understood as measured by the proxy force that the technician or assembler must apply to open door assembly 200 or to resist its closing. This force may be directly measured during adjustment of the balance of door assembly 200 or may be based on the technician's experience and/or guidelines for a desired force level as established by the manufacturer or other authority.

In some embodiments, such as that shown in FIG. 3, mounting apparatus 206 may be a ball screw having threads 220. Balancing mass 208 may have complementary threads 222 for attaching balancing mass 208 to mounting apparatus 206. In this and other embodiments, mounting apparatus 206 may have a first mounting position 210 at which balancing mass 208 may be attached and a second mounting position 212 at which balancing mass 208 may be attached. It may be known that a predetermined gravitational moment based on a door assembly 200 of a given mass and dimensions and a given torsional stiffness of hinge 204, balancing mass 208 may need to be positioned at the second mounting position 212. Balancing mass 208 may begin at first mounting position 210 and be adjusted by rotating one or more of mounting apparatus 206 and balancing mass 208 until balancing mass 208 is at second mounting position 212. In doing so, the center of gravity of door assembly 200 is raised, increasing the gravitational moment it exerts on hinge 204 to the predetermined amount.

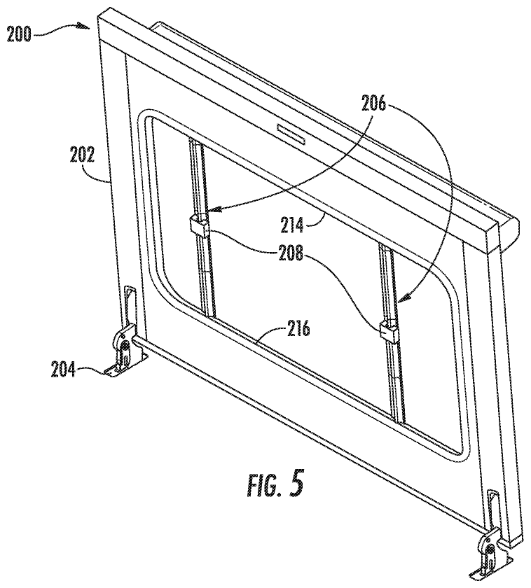

Mounting apparatus 206 need not be a ball screw, however. In other embodiments, mounting apparatus 206 may be an adhesive as shown in FIG. 4. In such embodiments, mounting apparatus may comprise one or more adhesives strip attached vertically or transversely on frame 202 or one or more series of adhesive patches distributed vertically or transversely on frame 202. One or more balancing masses 208 may be attached to an appropriate position on the adhesive mounting apparatus 206 to generate a predetermined gravitational moment on hinge 204. As such, it would be necessary in such embodiments to detach balancing masses 208 from mounting apparatus 206 to adjust the center of gravity by moving balancing masses 208 between first and second mounting positions.

Alternatively, in other embodiments, mounting apparatus 206 may be a clip mechanism, such as a din rail or guide rail as shown in FIG. 5. In such embodiments, one or more balancing masses 208 may be snapped into place at an appropriate location on the din rail or guide rail. In some embodiments, a protrusion on balancing mass 208 would be attached to a complementary receiving element on mounting apparatus 206. In alternative embodiments, mounting apparatus 206 may including a protrusion that would be attached to a complementary receiving element on balancing mass 208. Still other embodiments of mounting apparatus 206 may simply be one or more distributed series of pre-drilled holes (not pictured) in frame 202 with attaching screws, bolts, or the like. One or more balancing masses 208 may include corresponding holes through which the attaching means of the mounting apparatus 206 may be inserted to attach balancing masses 208 to mounting apparatus 206. Once again, the location of the holes upon the frame, coupled with the characteristics of door assembly 200 and balancing masses 208, would enable assembly to establish a predetermined gravitation moment about hinge 204.

Now that the construction of oven appliance 100 and door assembly 200 have been presented according to exemplary embodiments, an exemplary method 300 of operating balancing a door assembly of an appliance will be described. Although the discussion below refers to the exemplary method 300 of balancing door assembly 200 of oven appliance 100, one skilled in the art will appreciate that the exemplary method 300 is applicable to the balancing and/or assembly of any other suitable door for any other suitable appliance.

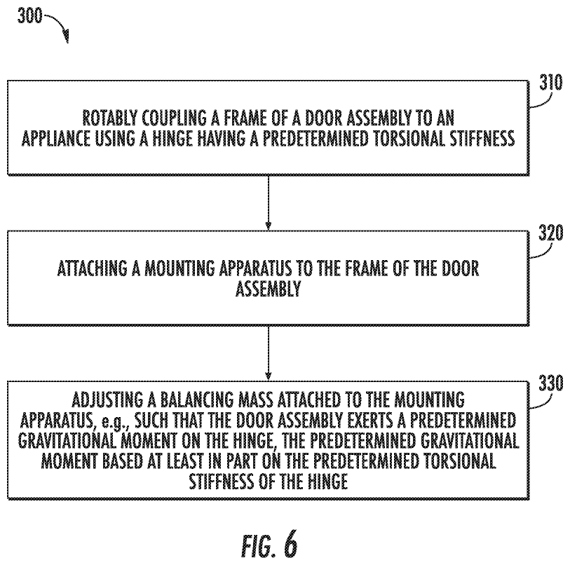

Referring now to FIG. 6, method 300 includes, at step 310, rotatably coupling a frame of a door assembly to an appliance using a hinge having a predetermined torsional stiffness. Step 320 may include attaching a mounting apparatus to the frame of the door assembly and step 330 may include adjusting a balancing mass attached to the mounting apparatus, e.g., such that the door assembly exerts a predetermined gravitational moment on the hinge, the predetermined gravitational moment based at least in part on the predetermined torsional stiffness of the hinge.

For example, continuing the example from above, method 300 may be implemented during the assembly and/or mounting of door assembly 200, e.g., by using mounting apparatus 206 to adjust the position of balancing mass 208. In this manner, the gravitational moment that door assembly 200 exerts on hinges 204 may be adjusted depending on the torsional stiffness of hinges 204.

FIG. 6 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using oven appliance 100 and door assembly 200 as an example, it should be appreciated that these methods may be applied to the assembly and/or balancing of any other suitable door assembly for any other suitable appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A door assembly for providing selective access to a chamber of an appliance, the door assembly comprising:
a frame defining a vertical, a lateral, and a transverse direction;
a hinge for rotatably coupling the frame to the appliance;
a mounting apparatus attached to the frame; and
a balancing mass positioned on the mounting apparatus such that the frame and the balancing mass exert a predetermined gravitational moment on the hinge, and wherein the balancing mass is at least partially contained within a volume defined by the frame.

2. The door assembly of claim 1, wherein the mounting apparatus further comprises a first mounting position at which the balancing mass may be attached and a second mounting position at which the balancing mass may be attached.

3. The door assembly of claim 2, wherein the balancing mass is adjustable between the first mounting position to exert a first gravitational moment on the hinge and the second mounting position to exert a second gravitational moment on the hinge.

4. The door assembly of claim 1, wherein the predetermined gravitational moment is selected based on a torsional stiffness of the hinge.

5. The door assembly of claim 3, wherein the frame further comprises an upper wall and a lower wall disposed opposite one another in the vertical direction and the mounting apparatus is oriented to extend between the upper wall and the lower wall such that adjustment of the balancing mass between the first mounting position and the second mounting position occurs in the vertical direction.

6. The door assembly of claim 3, wherein the mounting apparatus is a ball screw, the mounting apparatus and the balance mass defining complementary threads.

7. The door assembly of claim 3, wherein the mounting apparatus is an adhesive.

8. The door assembly of claim 3, wherein the mounting apparatus is a clip mechanism.

9. The door assembly of claim 3, wherein adjustment of the balancing mass between the first mounting position and the second mounting position involves detaching the adjustable mass from the mounting apparatus and reattaching the adjustable mass to the mounting apparatus.

10. The door assembly of claim 3, wherein the door assembly comprises multiple mounting apparatuses, each mounting apparatus configured to receive at least one balancing mass.

11. An oven appliance comprising:
a cabinet;
a cooking chamber positioned within the cabinet;
a door assembly rotatably mounted to the cabinet for providing selective access to the cooking chamber, the door assembly comprising:
a frame defining a vertical, a lateral, and a transverse direction;
a hinge for rotatably coupling the frame to the appliance;
a mounting apparatus attached to the frame; and
a balancing mass positioned on the mounting apparatus such that the frame and the balancing mass exert a predetermined gravitational moment on the hinge, and wherein the balancing mass is at least partially contained within a volume defined by the frame.

12. The oven appliance of claim 11, wherein the mounting apparatus further comprises at least a first mounting position at which the balancing mass may be attached and a second mounting position at which the balancing mass may be attached.

13. The oven appliance of claim 12, wherein the balancing mass is adjustable between at least the first mounting position of the mounting apparatus and the second mounting position of the mounting apparatus, the adjustment changing the gravitational moment exerted on the hinge.

14. The oven appliance of claim 11, wherein the predetermined gravitational moment is selected based on a torsional stiffness of the hinge.

15. The oven appliance of claim 13, wherein the frame further comprises an upper wall and a lower wall disposed opposite one another in the vertical direction and the mounting apparatus is oriented to extend between the upper wall and the lower wall such that adjustment of the balancing mass between the first mounting position and the second mounting position occurs in the vertical direction.

16. The oven appliance of claim 13, wherein the mounting apparatus is a ball screw, the mounting apparatus and the balance mass defining complementary threads.

17. The oven appliance of claim 13, wherein adjustment of the balancing mass between the first mounting position and the second mounting position involves detaching the adjustable mass from the mounting apparatus and reattaching the adjustable mass to the mounting apparatus.

18. The oven appliance of claim 13, wherein the door assembly comprises multiple mounting apparatuses, each mounting apparatus configured to receive at least one balancing mass.

19. A method of balancing a door assembly of an appliance, the method comprising:
rotatably coupling a frame of the door assembly to the appliance using a hinge having a predetermined torsional stiffness;
attaching a mounting apparatus to the frame of the door assembly; and
adjusting a balancing mass attached to the mounting apparatus.

20. The method of claim 19, wherein adjusting the balancing mass attached to the mounting apparatus comprises:
positioning the balancing mass such that the door assembly exerts a predetermined gravitational moment on the hinge, the predetermined gravitational moment based at least in part on the predetermined torsional stiffness of the hinge.
